(19) United States
(12) Patent Application Publication
(10) Pub. No.: US 2024/0170901 A1
(43) Pub. Date: May 23, 2024

(54) CRIMPING TOOL

(71) Applicant: SW AUTOMATISIERUNG GMBH, Golling an der Salzach (AT)

(72) Inventor: Rupert LINDNER, Kuchl (AT)

(21) Appl. No.: 18/428,642

(22) Filed: Jan. 31, 2024

Related U.S. Application Data
(62) Division of application No. 17/380,478, filed on Jul. 20, 2021.

(30) Foreign Application Priority Data
Jul. 21, 2020 (AT) A 50628/2020

(51) Int. Cl. H01R 43/055; H01R 43/048

(52) U.S. Cl. CPC H01R 43/055; H01R 43/0486

(57) ABSTRACT

A crimping tool including a main body, a force-applying device, and at least two crimping jaws for crimping a crimping connection to a conductor. The at least two crimping jaws are moveable relative to the main body by the force-applying device, and a compensating device which allows adoption of at least three processing positions of the at least two crimping jaws depending on a position of the force-applying device relative to the compensating device. A force storage means is arranged on the main body and allows, in a processing position of the at least two crimping jaws, in particular in which substantially no force can be transmitted to the at least two crimping jaws by the force-applying device, a force-locking connection to be made between the crimping connection and the at least two crimping jaws by a movement of the at least two crimping jaws relative to the main body.

### BACKGROUND OF THE INVENTION

The invention concerns a crimping tool, in particular for a wire processing machine, comprising a main body, at least one force-applying device and at least two crimping jaws for crimping at least one crimping connection to at least one conductor, and the at least two crimping jaws are moveable relative to the main body by the at least one force-applying device. In addition, the invention concerns a wire processing machine comprising at least one crimping tool, in particular at least one such crimping tool, at least one drive unit for producing force on at least one force-applying device and at least one movement device. The invention further concerns a method of crimping at least one crimping connection to at least one conductor by a wire processing machine, in particular by such a wire processing machine.

Such a crimping tool is already known from specification EP 0 732 779 in which a pressing system is used to be able to implement crimping with a quadrangular or hexagonal pressing profile. An outwardly disposed drive ring is actuated by a drive by way of a toggle lever assembly, the ring moving four or six pivotably mounted crimping jaws for the crimping procedure.

A disadvantage with the state of the art is that the crimping tool is not suitable for an automated arrangement of crimping connections to conductors and crimping of the crimping connections to the conductors—in particular in a wire processing machine.

A further crimping tool is already known from WO 2019/134834 in which a crimping operation is performed by rotation of a drive shaft arranged along an axis of symmetry of four crimping jaws.

A disadvantage with this state of the art in a first aspect is that there is an open position for feeding the crimping connections and a crimping position for the crimping operation, as the solely defined operating positions. Thus, functionality is restricted and, in particular, separate removal devices are necessary in order for example to be able to crimp a crimping connection of altered diameter, when the crimping connection is inserted. In addition, there is no information available as to whether the crimping operation was properly performed or whether the crimping operation was effected adequately in regard to specific quality criteria. In addition, the drive shaft is always in a condition of force-transmitting connection with the crimping jaws, in which case for example it is not possible to guarantee a position which is not completely opened of the crimping jaws with a crimping connection disposed therein, without premature crimping and/or without play—in particular for transport of the crimping connection.

A disadvantage with the state of the art in a second aspect is that a separate transport device is required, to maneuver the crimping connection to the crimping position. In addition the crimping tool by virtue of the structural configuration can only be fitted with crimping connections and conductors from one side of the crimping tool. In addition, no alternative is set forth for gripping the crimping connection gently by the drive shaft which is designed for a crimping operation, in which case in particular when dealing with delicate crimping connections there is the risk of premature crimping and/or wastage of the crimping connection.

### SUMMARY OF THE INVENTION

The technical object of the present invention is therefore that of providing a crimping tool which is improved over the state of the art, as well as a wire processing machine and a crimping method, in which the disadvantages of the state of the art are at least partially overcome and which are distinguished in particular by the possibility of automated, flexible fitment and removal at both sides of crimping connections and by a reduction in installation components separate from the crimping tool like a shuttle for transporting crimping connections to the crimping position.

Therefore, the invention includes at least one compensating device, by way of which depending on a relative position of the at least one force-applying device relative to the at least one compensating device at least three processing positions of the at least two crimping jaws can be adopted. A force storage means is arranged on the main body and by which in a processing position of the at least two crimping jaws, in particular in which substantially no force can be transmitted to the at least two crimping jaws by the at least one force-applying device, a force-locking connection can be made between the at least one crimping connection and the at least two crimping jaws by a movement of the at least two crimping jaws relative to the main body.

By virtue thereof, it is first possible that—in particular under the force of gravity—fitment with crimping connections, unloading of crimping connections after fitment has been effected, transport of crimping connections from a fitment position to a crimping position and also a crimping operation can be guaranteed, in which case for example there is no requirement for separate unloading devices and/or fitment devices.

Added thereto is the positive property that positions, defined by the at least one compensating device, of the at least one force-applying device—by way of example with respect to a hollow shaft—can be implemented for the movement of the at least two crimping jaws, whereby in dependence on the relative position of the at least one force-applying device relative to the at least one compensating device, specific positions of the at least two crimping jaws are set.

The at least one compensating device makes it possible for the at least one force-applying device to be moved with respect to the positions known from the state of the art into a position in which substantially no force can be transmitted to the at least two crimping jaws, wherein that position can be used for example to transport the at least one crimping connection without unintentionally crimping the crimping connection by the at least one force-applying device or losing it.

The technical term crimping is defined by a joining method wherein two components are connected by means of pressing by way of plastic deformation. Beading, crushing, flanging or folding can be associated with that joining method. In this context, pressing is effected by the at least two crimping jaws of the crimping tool whereby a positively locking connection is generated between the crimping connection and the conductor.

The at least one force-applying device can be arranged for example in the manner of contact against the at least one compensating device and/or can be moveably arranged for example region-wise within the at least one compensating device.

In addition, it is now possible in accordance with the invention that, in a pivotal movement of the crimping tool from a fitment position into a crimping position, the at least one crimping connection remains located securely in position in the at least two crimping jaws. In addition, no plastic deformation is implemented by the crimping tool before the crimping position, in which respect that situation cannot be guaranteed in the state of the art by virtue of the high pressing forces generated by way of the drive unit—in particular with varying crimping connection diameters.

The at least one force-storage means preferably has a spring constant which, for different crimping connection cross-sections, permits a force-locking connection in the crimping tool upon transition from a fitment position to a crimping position without premature force-locking connection being generated by virtue of excessively high pressures acting between the at least two crimping jaws. That involves particularly favorable feed of the at least one conductor to the at least one crimping connection in the crimping position.

The at least one force storage means acts preferably in that relative position of the at least one force-applying device with respect to the at least one compensating device, in which substantially no force acts on the at least two crimping jaws by virtue of the at least one force-applying device.

In the state of the art, by virtue of the drive for the drive shaft which has to transmit high pressing forces for the crimping operation it is not possible to ensure that a crimping connection is held gently with the guarantee of a force-locking connection without a positively locking connection. That problem is resolved by the at least one force storage means, wherein acount is also taken of the dimensional tolerances arising in practice in respect of the at least one crimping connection, which cannot be compensated by way of standard drive units.

The crimping tool can be used for example in a stand-alone apparatus as a crimping machine or in a fully automated wire production machine.

As stated in the opening part of this specification protection, a wire processing machine includes at least one such crimping tool, and at least one drive unit for producing force on the at least one force-applying device and at least one movement device. The at least one crimping tool is moveable by the at least one movement device, preferably between a fitment position and a crimping position, particularly preferably pivotably about a horizontal axis, and the force-locking connection can be maintained during a movement of the at least one crimping tool by the at least one movement device.

The at least one movement device provides that the at least one crimping tool together with the at least one drive unit can be moved from a vertical fitment position in which the at least one crimping connection can drop under the force of gravity into the at least one crimping tool to a horizontal crimping position, wherein the at least one crimping connection remains located in the at least one crimping tool between the fitment position and the crimping position. A force storage means which is possibly provided can ensure a force-locking connection during the movement, in which case an undesirably high pressing force is avoided by the at least one force-applying device. The cable processing machine can be in the form of a wire end processing machine.

The wire processing machine for example can be in the form of an in particular automated crimping machine, wire end processing machine, processing machine with included insulation stripping device or the like.

In general, movement is possible in all degrees of freedom—in particular a linear movement and/or a pivotal movement—of the crimping tool by the at least one movement device, so that no transport device separate from the at least one crimping tool is required for transporting a crimping connection to the crimping position.

As stated in the opening part of this specification, a method of crimping at least one crimping connection to at least one conductor by such a wire processing machine includes the following method steps which are to be carried out in particular in chronological sequence:
the at least two crimping jaws of the at least one crimping tool are moved into an open position by the at least one force-applying device, in particular by way of at least one hollow shaft,
in a fitment position the at least one crimping connection is fed to the at least two crimping jaws,
the at least one force-applying device is moved relative to the at least one compensating device, wherein the at least two crimping jaws transition into a holding position in which the at least one crimping connection is arranged in force-locking relationship between the at least two crimping jaws,
the at least one crimping tool is moved by at least one movement device from the fitment position into a crimping position, in particular about a horizontal axis,
the at least one conductor is arranged region-wise within the at least one crimping connection, and
the at least one force-applying device moves the at least two crimping jaws into a crimping position, in particular by way of the at least one hollow shaft.

A shuttle for transporting the at least one crimping connection is not required in that case and fitment with crimping connections can be effected at both sides automatically from a front side and a rear side of the at least one crimping tool.

In the state of the art, the conductor is moved to the crimping tool. The crimping tool and/or the wire processing machine make it possible for the at least one crimping connection to be moved by the crimping tool to the at least one conductor.

The operating positions of the at least one hollow shaft geometrically correspond to the processing positions of the at least two crimping tools.

According to a particularly preferred embodiment of the invention, the at least one compensating device is arranged preferably in peripheral relationship at at least one hollow shaft. Depending on a relative position of the at least one force-applying device relative to the at least one compensating device, at least two operating positions of the at least one hollow shaft can be adopted and at least three processing positions of the at least two crimping jaws can be adopted by way of the at least three operating positions of the at least one hollow shaft.

Misfeeds can be eliminated without manual intervention or machine stoppage by the at least one hollow shaft. By virtue of the at least one hollow shaft the required crimping force can be transmitted radially inwardly by way of the at least two crimping jaws, and fitment and removal of crimping connections and conductors can be implemented flexibly at both sides—in particular in automated fashion—by virtue of the structural configuration.

Particularly preferably, the force-applying device is in the form of an ecentric lever arranged on an ecentric drive unit which—in particular in peripheral relationship—engages the at least one hollow shaft and by force actuation of the at least one hollow shaft moves the at least two crimping jaws for the crimping operation.

Particularly preferably, the crimping tool has at least one hollow shaft, and the force storage means is arranged at the at least one hollow shaft, preferably in peripheral relationship.

The at least one hollow shaft can be for example in the form of a drive ring.

The at least one hollow shaft in combination with the at least one force storage means makes it possible for the at least one crimping connection both to be held gently for transport and also to be able to substantially instantly initiate crimping with high pressing forces, in which case fitment or loading at both sides is particularly promoted.

In an advantageous configuration of the invention, the at least two crimping jaws are moveably mounted preferably by way of at least one connecting means to the at least one hollow shaft and wherein the at least two crimping jaws are moveable by way of the at least one hollow shaft into a plurality of processing positions, preferably an ejection position, an open position, a holding position and/or a crimping position.

That permits movement coupling between the at least two crimping jaws and the at least one hollow shaft whereby, upon rotation of the at least one hollow shaft, the at least two crimping jaws respectively increase or reduce a spacing relative to each other to be able to eject, receive, hold and/or crimp a crimping connection. A cycle time can be reduced by ejection by way of a rear side of the crimping tool and loading by way of the front side of the crimping tool.

In the open position, a crimping connection for example of a crimping connection diameter of 2.1 mm can be fitted into an opening defined by the crimping jaws of 2.4 mm in diameter with a clearance, in which case in the holding position the opening is reduced by the crimping jaws to 2.1 mm in order to hold the crimping connection without clearance in force-locking relationship without positively locking involvement and the opening is possibly increased in the ejection position to a size with which the crimping connection together with a plastic collar can be removed from the crimping tool automatically without machine involvement.

It has proven to be particularly efficient if the at least one crimping connection is arranged by the crimping tool around the at least one conductor and substantially immediately thereafter crimping is effected by way of the crimping position of the at least two crimping jaws. In general, the at least one conductor can also be moved in the direction of the at least one crimping connection.

Particularly preferably, the ejection position is geometrically defined by a dead point position of the at least one force-applying device at a drive unit and/or by abutments in indentations in the at least one hollow shaft for the at least two crimping jaws and/or at least one connecting element. An abutment for the at least one force-applying device is also possible.

Particularly preferably, the at least one connecting means is connected hingedly to the at least two crimping jaws and/or the at least one hollow shaft, preferably by mounting pins. In addition, particularly preferably the at least two crimping jaws are hingedly connected, preferably by mounting pins, to the at least one hollow shaft, by at least one mounting ring.

Advantageously, the at least one connecting means is rotatably mounted, preferably by at least one mounting pin, at the at least one hollow shaft, at at least one mounting ring and/or at the at least two crimping jaws. Advantageously, the at least two crimping jaws are rotatably mounted preferably by at least one mounting pin at the at least one hollow shaft and/or at at least one mounting ring. The crimping tool, however, is not limited to a movement of the at least two crimping jaws by the at least one connecting means.

It has proven to be advantageous if the at least one crimping connection can be connected in the holding position of the at least two crimping jaws by the at least one force storage means in force-locking relationship to the at least two crimping jaws. Preferably, the at least one hollow shaft can be rotated by a pulling force of the at least one force storage means from the open position into the holding position of the at least two crimping jaws and can be held in the holding position.

In that way, it is possible, in a relative position between the at least one force-applying device and the at least one compensating device, in which no force is transmitted by the at least one force-applying device to the at least one hollow shaft, for the tensile force of the at least one force storage means to implement a force-locking connection of the at least one crimping connection to the crimping tool. Particularly preferably, the pulling force is so selected that crimping connections of different diameters remain located in a fixed position in the crimping tool during transport by the crimping tool. Upon rotation of the at least one hollow shaft the crimping jaws can generally rotate, be linearly moved and/or perform a combination of rotary movement and linear movement.

According to an advantageous embodiment of the invention, the crimping tool includes precisely two, precisely four, or precisely six crimping jaws.

Varying crimping profiles can be generated by a differing number of crimping jaws. Trapezoidal crimping profiles, rectangular crimping profiles and hexagonal crimping profiles have proven to be particularly preferred.

It has proven to be advantageous if the at least one force-applying device includes at least one rod, preferably at least one connecting rod, with at least one pin connected particularly preferably in material-bonded relationship to the at least one connecting rod for the transmission of force to the at least one hollow shaft, wherein it is preferably provided that the at least one rod has a receiving means for force-transmitting connection to at least one drive unit.

The at least one rod can provide for rotation of the at least one hollow shaft, particularly preferably by virtue of the at least one force-applying device—in particular with a drive unit in the form of a linear motor. With a connecting rod—for example initiated by a servo motor as an ecentric drive—it is possible to provide for advantageous transmission of force to the hollow shaft by conversion of rotational energy into translational energy.

An advantageous variant provides that the at least one compensating device is in the form of at least one opening, preferably at least one slot, wherein it is preferably provided that at least one pin which is possibly present is moveable particularly preferably linearly in the at least one opening.

The compensating device is particularly preferably arranged in material-bonded relationship to the at least one hollow shaft. The compensating device permits a defined approach of specific operating positions of the at least one hollow shaft by way of the at least one force-applying device. In a manner corresponding to the positions of the at least one hollow shaft, the at least two crimping jaws can also be moved into the position required for a processing step.

Particularly preferably, the at least one force storage means is in the form of a spring, preferably a tension spring. In general, however, the force storage means can also be in the form of a fluid force storage means like a pneumatic or hydraulic force storage means.

It has proven to be particularly desirable if the force storage means implements the force-locking connection in the holding position of the at least two crimping jaws in the state of inactivity of the at least one force-applying device, wherein the force-applying device is located in an inactive relative position with respect to the at least one compensating device.

In general, the at least one force storage means can also be formed by a further drive unit, preferably with a further force-applying device, wherein the further drive unit is to be adapted to a force-locking engagement of the crimping connections with the crimping jaws without unwanted positively locking connection. In the state of the art, the high required crimping forces to be transmitted for the crimping operation by the drive shaft are not suitable for that purpose.

In an embodiment of the invention, the crimping tool has a through opening, through which the at least one crimping connection in an operating position of the at least one hollow shaft, particularly preferably in automatic fashion at both sides, can preferably be removed by at least one unloading device and/or can be loaded preferably by at least one loading device. There can be generally any number of through openings.

In that way, it is possible for a crimping connection which is not wanted—for example due to altered demands on the crimping—to be ejected or removed from the crimping tool. In addition, fitment with crimping connections and a feed of the at least one conductor is possible at both sides from a front side and a rear side of the crimping tool. The through opening extends particularly preferably over the entire crimping tool, in particular over the main body, the at least one hollow shaft and a mounting ring which is possibly present.

In a preferred embodiment of the invention, the at least one crimping connection is in the form of a wire end ferrule, a cable shoe, and/or a flat blade receptacle. In general, however, other kinds of crimping connections for cable manufacture like turned contacts are also possible. The wire end ferrules can be designed with or without plastic collars, and/or of a variable wire end ferrule length.

It has proven to be desirable that the at least one crimping connection and/or the at least one conductor, preferably in an optionally provided ejection position of the at least two crimping jaws can be fed and/or removed from a front side and/or a rear side of the crimping tool.

The feed and/or removal of the at least one crimping connection can be effected fully automatically, semi-automatically or manually and/or in any position of the crimping tool in space.

Preferably, there is arranged at the crimping tool, preferably at the at least one force-applying device, at least one sensor, preferably at least one force measuring sensor and/or at least one travel measuring sensor for ascertaining at least one crimping parameter.

The at least one sensor makes it possible to measure operating parameters which are relevant for the crimping tool and/or a wire processing machine like the pressing force of the at least two crimping jaws or the distance covered by the at least one force-applying device, wherein particularly preferably it is possible to calculate conclusions about further crimping parameters by suitable mathematical modeling.

Alternatively, it is possible for the at least one drive unit to be in the form of an electric drive unit, preferably in the form of a servo motor and/or a linear motor.

In a further embodiment, the at least one crimping tool includes at least one force-applying device which can be subjected to force by the at least one drive unit, wherein arranged at the at least one force-applying device is at least one compensating device while the at least one compensating device is arranged at at least one hollow shaft. Depending on a relative position of the at least one force-applying device, relative to the at least one compensating device, at least three operating positions of the at least one hollow shaft can be adopted.

The at least three operating positions can be brought about in any pivotal position of the at least one crimping tool (implemented by the at least one movement device).

According to an advantageous configuration of the invention, the crimping tool includes at least one hollow shaft and at least one force storage means arranged at the at least one hollow shaft. A force-locking connection can be made between the at least one crimping connection and the at least two crimping jaws by the at least one force storage means in an operating position of the at least one hollow shaft, and preferably the force-locking connection can be maintained during a pivotal movement by the at least one movement device.

The force-locking connection is particularly preferably generated by a further transmission of force from the at least one hollow shaft by way of at least one connecting element to the at least two crimping jaws.

According to an advantageous configuration of the invention, transport of the at least one crimping connection from the fitment position to the crimping position and crimping of the at least one crimping connection to the at least one conductor in the crimping position can be effected with the same crimping tool. Preferably, crimping can be carried out substantially directly after transport to the crimping position by the crimping tool.

As a result, there is no need for a shuttle for the transport of the at least one crimping connection to the crimping position and crimping can be effected in a particularly expedited fashion by a reduction in the crimping cycle time. In addition, this reduces susceptibility to faults by virtue of over-gripping devices and/or other kinds of transport devices.

Advantageously, the at least one crimping tool is pivotable by way of the at least one movement device into a fitment position in which the at least one crimping connection can be fed under the force of gravity substantially vertically to the at least two crimping jaws and/or into a crimping position spatially separate from the fitment position. At least one crimping connection in the fitment position and/or the crimping position, can be removed, particularly preferably automatically, preferably by at least one unloading device, from the at least two crimping jaws, and/or can preferably be fed by way of at least one loading device to the at least two crimping jaws and/or the at least one conductor can be arranged in the crimping position in the at least one crimping connection.

Particularly preferably, the at least one crimping connection drops from a magazine with different crimping connection diameters in the open position of the at least two crimping jaws between the at least two crimping jaws, in which case the at least one crimping tool can be individually pivoted to a position at the magazine, that contains the desired crimping connection diameter. If an altered crimping connection diameter is required the at least one crimping tool can transition into the ejection position and the previous crimping connection drops out of the crimping tool. When the correct crimping connection is between the at least two crimping jaws the crimping connection can be held in force-locking relationship in the holding position by the at least one force storage means and can be pivoted together with the crimping tool into the crimping position, in which case a crimp can be produced after a feed of at least one conductor by a feed transfer device into the crimping position.

It has proven to be desirable that at least one sensor, preferably at least one force-measuring sensor and/or at least one travel-measuring sensor, is arranged at the at least one crimping tool, preferably at the at least one force-applying device and/or the at least one drive unit, for ascertaining at least one crimping parameter. In general, the at least one drive unit can also store required travel distances for different crimping connection diameters, which can be reviewed by measurement data of the at least one sensor.

According to an advantageous embodiment of the invention, at least one actual value in relation to at least one crimping parameter, preferably in relation to a position of the at least one drive unit and/or at least one distace covered by the at least one force-applying device, can be ascertained by the at least one sensor.

It has proven to be advantageous for at least one open-loop and/or closed-loop control unit to include at least one memory unit and at least one computing unit and the memory unit stores and/or can store at least one target value in relation to a crimping parameter. Preferably, the at least one target value can be compared to at least one actual value by the at least one computing unit.

By making a comparison between the at least one target value and the at least one actual value, it is possible for example to specify whether the crimping implemented corresponds to defined quality criteria like a degree of plastic deformation or whether prior to the crimping plastic deformation of the at least one crimping connection was already generated.

An advantageous variant provides that there is at least one display device which is in signal-transmitting data communication with the at least one open-loop and/or closed-loop control unit or can be put into such a communication state. An electronic message can be output by the at least one display device in dependence on the comparison of the at least one target value with the at least one actual value.

In that way, it is possible to notify an operator of the cable processing machine that crimping was properly implemented and/or an action like rejection of the connection of the crimping connection to the conductor is required.

It is particularly preferable if the at least one crimping connection and/or the at least one conductor, preferably in an ejection position of the at least two crimping jaws, can be fed and/or removed from a front side and/or a rear side of the at least one crimping tool in any position of the at least one movement device.

In an embodiment of the invention, the at least one crimping connection is held in the holding position and/or during the movement out of the fitment position into the crimping position by the at least one force storage means by a force-locking connection between the at least one crimping connection and the at least two crimping jaws in the at least one crimping tool.

Particularly preferably, in the holding position substantially no force is transmitted from the at least one force-applying device to the at least one hollow shaft. By virtue of a movement of the at least one force-applying device, the force-locking connection can transition into a positively locking connection or release of the force-locking connection can occur.

In a preferred embodiment of the invention, in the crimping position a connection between the at least one crimping connection and the at least one conductor can be made with a quadrangular profile, a polygonal profile and/or a trapezoidal profile. The crimping connection profile is generally defined by the number of crimping jaws and/or the orientation of the at least two crimping jaws relative to each other. Particularly preferably, there are four crimping jaws arranged symmetrically relative to each other.

It has proven to be desirable if the at least one conductor in the crimping position is fed preferably linearly to the at least one crimping connection arranged in the at least one crimping tool and/or the at least one crimping connection arranged in the at least one crimping tool is moved preferably linearly in the direction of the at least one conductor.

In the state of the art, the at least one conductor is always moved in the direction of the crimping tool. In that respect greater flexibility is afforded by the possibility of the at least one crimping connection being moveable by the crimping tool both from a fitment position into the crimping position and also, with a conductor positioned in a secure position, to the conductor.

Preferably, at least one open-loop and/or closed-loop control unitcan:
determine at least one actual value by at least one sensor in relation to at least one crimping parameter compared to at least one target value in relation to at least one crimping parameter,
evaluate and/or effect quality control preferably by an algorithm by comparison operations, preferably over a defined period of time,
categorize the connection of the at least one crimping connection to the at least one conductor,
output an electronic message to at least one display device in relation to a quality of the connection of the at least one crimping connection to the at least one conductor, and/or
effect a measure prior to and/or after the crimping operation, preferably in the form of removal of the at least one crimping connection, reject of the at least one connection of the at least one crimping connection to the at least one conductor and/or the like.

The at least one open-loop and/or dosed-loop control unit makes it possible to carry out an analysis of the crimping method, wherein trouble-free implementation of the crimping operation can be monitored by consideration of crimping parameters to be determined and/or which are stored, wherein statistical consideration is also made possible for quality control by way of a history of the cable processing machine. A risk of crimpings of inferior quality is considerably reduced thereby. The algorithm can include machine learning, artificial intelligence or suitable mathematical models.

Particularly preferably, evaluation of capacity utilization figures of the at least one drive unit is effected by the at least one open-loop and/or closed-loop control unit, and the at least one open-loop and/or closed-loop control unit can be integrated in the at least one drive unit and/or can be separate from the at least one drive unit.

The force value involved in the crimping operation, as a crimping parameter, provides information about the pressing resistance to be overcome, based on the at least one conductor in combination with the at least one crimping connection arranged thereon. A force-travel assessment can be used for quality control of the crimping process and for suitable measures upon deviations from defined crimping parameters like a measurement in respect of the positively locking engagement of the crimping and/or operating parameters like the degree of capacity utilization of the drive unit. The force values, that is to say the pressing resistance, in combination with the travel values, afford on the one hand a crimping process window which is characteristic of the respective pressing situation for an automated crimping process quality control and on the other hand permit any missing wire strands of the at least one conductor, any flawed crimping connections in cross-section, length or other quality deficiencies to be detected.

A position of the at least one force-applying device as well as a degree of capacity utilization of the at least one drive unit can be ascertained very precisely, in which respect a required crimping force value for the crimping operation can be calculated by way of the crimping connection diameter. If the required crimping force value is exceeded or undershot beyond a tolerance, wherein that can be ascertained by the at least one sensor and/or can be determined by the at least one open-loop and/or closed-loop control unit, the connection can automatically be removed as waste and/or a modified crimping connection can be positioned in the crimping tool.

Alternatively, it is possible that the at least one open-loop and/or closed-loop control unit monitors the method having regard to the operating parameters of the at least one drive unit, an angular position of the at least one force-applying device and/or a crimping force transmitted by the at least one force-applying device and/or associates a degree of crimping to a connection of the at least one crimping connection to the at least one conductor.

That makes it possible to check a quality of the crimp, in which case for example in the event of a deviation from a desired crimping force or a degree of crimp operating parameters of the wire processing machine can be adjusted. The degree of crimp reflects the degree of pressing and is individually adaptable to specific crimping connection diameters and/or conductor diameters, wherein the respectively required pressing force can be automatically adjusted by the at least one drive unit and can be monitored by way of the at least one sensor.

In an advantageous configuration of the invention, in a preceding method step, a portion of a sheathing of a cable can be stripped off to expose the conductor of the cable by way of an automated insulation stripping device, preferably of the wire processing machine.

Before the conductor is fed to the crimping connection or the crimping connection to the conductor the wire processing machine can remove the sheathing arranged around the conductor or the insulation of the in particular electronic cable. The conductor can be formed by an individual wire or by a plurality of wire strands.

Particularly preferably, the at least one crimping connection and/or the at least one conductor is removed preferably in an ejection position of the at least two crimping jaws from a front side and/or a rear side of the at least one crimping tool through a through opening of the at least one crimping tool, particularly preferably automatically, preferably by at least one unloading device, and/or can be loaded preferably by at least one loading device.

The at least one unloading device and/or at least one loading device can be designed to be fully automatically operable. An unloading mandrel and/or a loading mandrel have proven to be particularly desirable. Particularly preferably the through opening is of a cylindrical configuration.

### BRIEF DESCRIPTION OF THE DRAWINGS

Further details and advantages of the present invention will be described more fully hereinafter by means of the specific description with reference to the embodiments by way of example illustrated in the drawings in which:

FIGS. 1a-1b are perspective views of a crimping tool according to a preferred embodiment in a crimping position and a fitment position,

FIG. 2 shows a wire processing machine according to a preferred embodiment with a drive unit, a movement device, an open-loop and/or closed-loop control unit and a crimping tool according to the embodiment shown in FIG. 1a in an exploded view,

FIG. 3a is a perspective view of a crimping tool according to a further preferred embodiment in a fitment position,

FIG. 3b shows a wire processing machine according to a further preferred embodiment with a crimping tool according to the embodiment of FIG. 3a in an exploded view,

FIGS. 4a-4b shows the wire processing machine according to the embodiment of FIG. 2 in an open position and a holding position in respect of four crimping jaws in a view from the front,

FIGS. 4c-4d shows a wire processing machine according to a further embodiment having six crimping jaws in an open position and a holding position in a view from the front,

FIGS. 5a-5b show the wire processing machine according to the embodiment of FIG. 4a and FIG. 4c respectively in a crimping position in a view from the front,

FIG. 6 shows the wire processing machine according to the embodiment of FIG. 2 in an ejection position of the four crimping jaws in a sectional view and a view from the front,

FIGS. 7a-7b show the wire processing machine according to the embodiment of FIG. 2 in the ejection position during loading and removal of a crimping connection from the crimping tool as a sectional view,

FIG. 8 shows a wire processing machine according to a further embodiment having a crimping tool as shown in FIG. 1a and a movement device in a perspective view,

FIGS. 9a-9b shows the wire processing machine according to the embodiment of FIG. 8 with a horizontally and a vertically arranged crimping tool in a perspective view, and

FIGS. 10a-10b show the wire processing machine according to the embodiment of FIG. 8 with the crimping tool in two crimping positions.

### DETAILED DESCRIPTION OF THE INVENTION

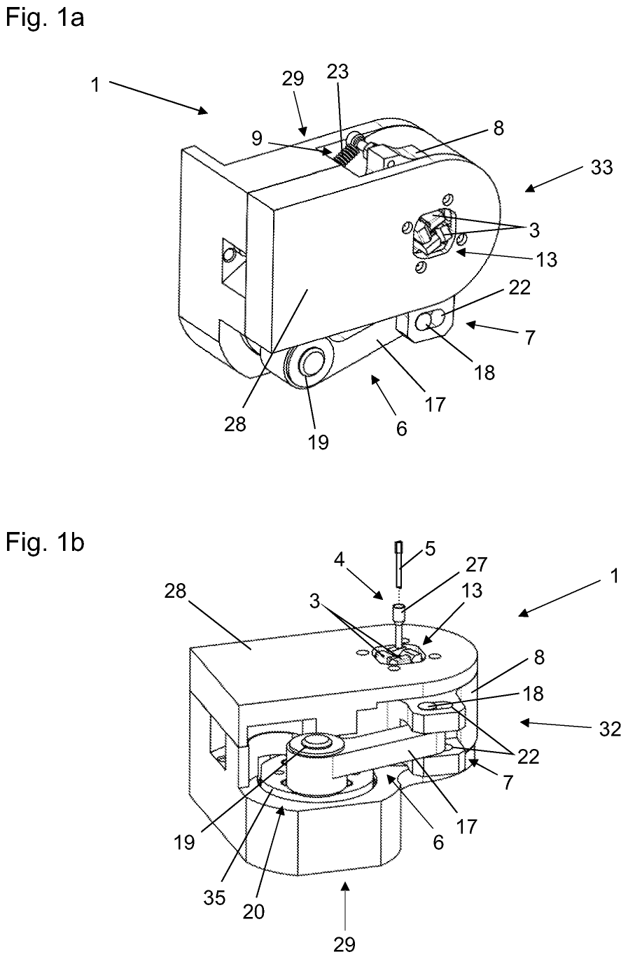

FIG. 1 shows a crimping tool 1 for a wire processing machine 2 having four crimping jaws 3 for crimping a crimping connection 4 to a conductor 5. The crimping tool 1 includes a force-applying device 6, wherein a compensating device 7 is arranged at the force-applying device 6, wherein the compensation device 7 is connected at the periphery in material-bonded relationship to a hollow shaft 8 at an external peripheral surface of the hollow shaft 8 in the form of a drive ring.

Four operating positions of the hollow shaft 8 can be adopted in defined fashion in dependence on a relative position of the force-applying device 6 relative to the compensating device 7.

The crimping tool 1 includes a force storage means 9 arranged in peripheral relationship at the hollow shaft 8, wherein exclusively a force-locking connection 10 (without positively locking connection) of a crimping connection 4 (not shown in the view for the sake of simplicity of the drawing) and the four crimping jaws 3 can be produced by the force storage means 9 in an operating position of the hollow shaft 8, in which the force-applying device 6 exerts substantially no force on the compensating device 7.

The compensating device 7 is in the form of an opening 21 in the shape of a slot 22, wherein a pin 18 is linearly moveable in the slot 22.

FIG. 1b shows the crimping connection 4 in the form of a wire end ferrule 27 with a plastic collar of varying diameter in relation to a crimping connection diameter. In general instead of the wire end ferrule 27 it is also possible to fit a cable shoe or a flat blade receptacle between the crimping jaws 3.

The conductor 5 was already freed of a portion of a sheathing (shown in a dotted line) of a cable to expose the conductor 5 of the cable in a preceding method step by way of an automated insulation stripping device of the wire processing machine 2. The conductor 5 was only indicated for illustration purposes in the view in order to clearly show positioning thereof relative to the crimping connection 4 as the crimping tool 1 is shown in the fitment position 32 in which the crimping connection 4 is fed in the direction of the crimping jaws 3 under the force of gravity.

After pivotal movement of the crimping tool 1—for example through 90° about a horizontal axis 34—the conductor 5 is fed in the crimping position 33 linearly to the crimping connection 4 disposed in the crimping tool 1. In general, the crimping connection 4 disposed in the crimping tool 1 can also be moved linearly in the direction of the conductor 5 in order then to implement the crimping operation.

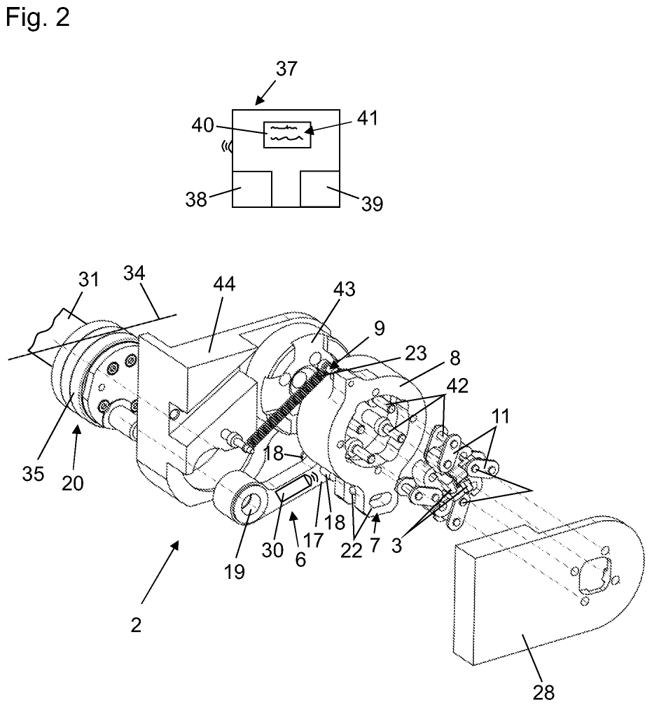

FIG. 2 shows a wire processing machine 2 having a crimping tool 1, a drive unit 20 for producing a driving force on the force-applying device 6 and a movement device 31. The movement device 31 is diagrammatically indicated and is not shown in the further Figures for the sake of clarity of the drawing; the movement device 31 can generally be formed by a robot arm or by some other rotational and/or translational component like for example a pivotal arm—which in particular is operated pneumatically.

The crimping tool 1 is pivotable about a horizontal axis 34 by the movement device 31 between the fitment position 32 and the crimping position 33. In general however the crimping tool 1 can be pivoted about any axis and/or can be moved along any axes. The crimping tool 1 is pivotable by way of the movement device 31 into a fitment position 32 in which the crimping connection 4 can be fed vertically to the four crimping jaws 3 under the force of gravity and is pivotable into a crimping position 33 which is spatially separate from the fitment position 32.

The crimping jaws 3 are moveable relative to a main body 44 by the force-applying device 6, wherein four defined processing positions of the crimping jaws can be adopted by way of the compensating device 7 arranged at the force-applying device 6. The processing positions correspond to four operating positions of the hollow shaft 8, defined by the compensating device 7, wherein the processing positions are not limited to a hollow shaft 8.

An open-loop and/or closed-loop control unit 37 is provided, wherein the open-loop and/or dosed-loop control unit 37 includes a memory unit 38 and a computing unit 39. The open-loop and/or closed-loop control unit 37 has a radio module in order to communicate with a sensor 30 (not shown) of the drive unit 20 and a radio module of a sensor 30 arranged on the force-applying device 6. In general the open-loop and/or closed-loop control unit 37 can also be connected by a wired connection to the drive unit and/or a sensor 30.

Target values in respect of crimping parameters are and can be stored in the memory unit 38, wherein the target values are compared to actual values ascertained by the sensor 30 by way of the computing unit 39. The open-loop and/or closed-loop control unit 37 can be for example an integral constituent part of a machine control system.

There is provided a display device 40 which is in signal-transmitting data communication with the open-loop and/or dosed-loop control unit 37. Depending on the comparison of the target values with the actual values an electronic message 41 is output by way of the display device 40.

The four crimping jaws 3 are mounted rotatably to a mounting ring 43 by way of mounting pins 42, the mounting ring 43 being connected to the hollow shaft 8, wherein upon rotation of the hollow shaft 8 the crimping jaws 3 perform a superimposed movement in the direction of the further crimping jaws 3 in order to reduce a spacing between the crimping jaws 3 whereby a crimp can be produced.

A respective connecting means 11 is rotatably mounted to the four crimping jaws 3 by way of a respective mounting pin 42, wherein the four connecting means 11 are respectively rotatably mounted to the hollow shaft 8 by way of a respective mounting pin 42. Upon a rotation of the hollow shaft 8—for example initiated by the ecentric drive by way of the at least one force-applying device 6—the crimping jaws 3 pivot by a kinematic interaction between the mounting pins 42 which are arranged in secured position on the mounting ring 43 and the mounting pins 42 arranged on the hollow shaft 8, inwardly or outwardly respectively.

At an inner peripheral surface the hollow shaft 8 has recesses which define an ejection position. In general the ejection position can also be defined (in particular in respect of control technology) by the drive unit 20 or by way of an abutment of the force-applying device 6 (in particular on a structural component of the wire processing machine 2).

The force-applying device 6 includes a rod 16 in the form of a connecting rod 17 with two pins connected in material-bonded relationship to the connecting rod 17 for transmission of force to the hollow shaft 8. The connecting rod 17 has a receiving means 19 for a force-transmitting connection to the drive unit 20.

The drive unit 20 is an electrical drive unit in the form of a servo motor 35.

By way of the open-loop and/or closed-loop control unit 37 an actual value determined by way of the sensor 30 in relation to a crimping parameter is compared to a target value in relation to a crimping parameter, evaluation and quality control is effected by an algorithm and by comparisons over a defined period of time, the connection of the crimping connection 4 to the conductor 5 is categorized, an electronic message 41 is output at the display device 40 in relation to a quality of the connection of the crimping connection 4 to the conductor 5 and a measure is implemented prior to and after the crimping operation. The measure can be for example a non-implementation of a intervention in the crimping process, a removal of the crimping connection 4, a rejection of the connection of the crimping connection 4 to the conductor 5 or changes in operating parameters of the wire processing machine 2.

The open-loop and/or closed-loop control unit 37 monitors the crimping method having regard to operating parameters of the drive unit 20, an angular position of the force-applying device 6 and a crimping force transmitted by the force-applying device 6 and associates a degree of crimping to a connection of the crimping connection 4 to the conductor 5.

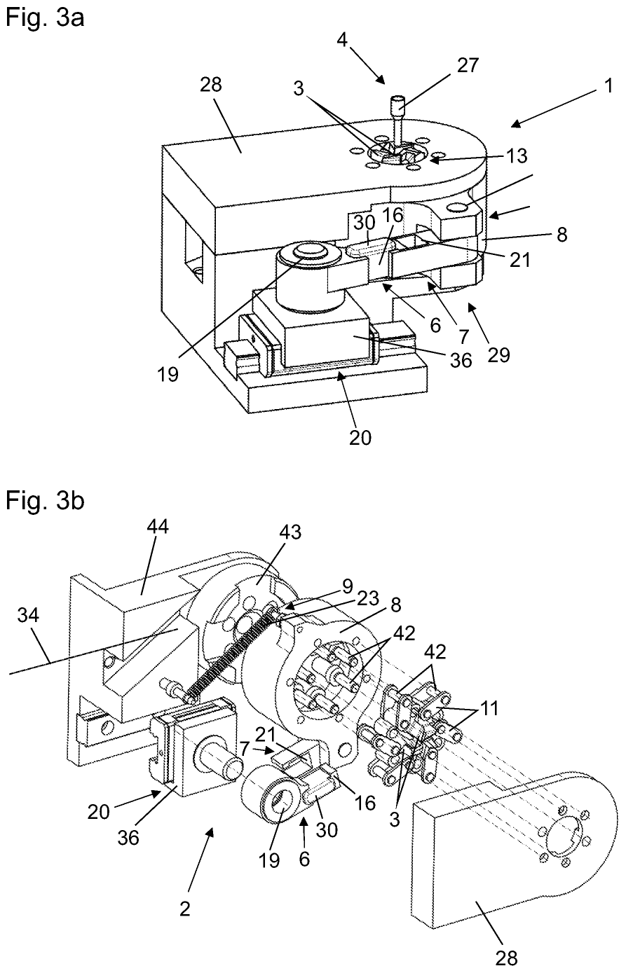

FIG. 3a differs from FIG. 1b insofar as the compensating device 7, the force-applying device 6 and the drive unit 7 are structurally modified. The compensating device 7 has an opening 21 in which a rod 16 is linearly moveable to generate the operating positions of the hollow shaft 8. A sensor 30 is integrated in the rod 16. The drive unit 20 is an electrical drive unit in the form of a linear motor 36.

In general the drive unit 20 can also be in the form of a mechanical, pneumatic, hydraulic and/or cam-controlled drive unit 20.

FIG. 3b shows a wire processing machine 2, wherein the movement device 31 is not shown for the sake of simplicity of the drawing. The crimping tool 1 has six crimping jaws 3 whereby a hexagonal crimping profile is produced in a crimping operation.

The force storage means 9 is in the form of a spring 23 in the form of a tension spring. The force storage means 9 is not limited to that configuration.

The sensor 30 arranged at the force-applying device 6 includes a force measuring sensor and a travel measuring sensor for ascertaining crimping parameters.

Transport of the crimping connection 4 from the fitment position 32 (see FIG. 3a) to the crimping position 33 (see FIG. 1a) and crimping of the at least one crimping connection 4 to the conductor 5 in the crimping position 33 is carried out with the same crimping tool 1. Crimping is effected immediately after transport to the crimping position 33 by the crimping tool 1.

The hollow shaft 8 is mounted by way of a mounting ring 43 on the main body 44. A cover serves as an axial mounting means for the hollow shaft 8 and as a counterpart mounting for the mounting pins 42. The mounting pins 42 arranged on the connecting elements 11 and the crimping jaws 3 are in the form of spindles. The mounting pins 42 are fitted into the mounting ring, with the crimping jaws 3 being mounted pivotably to the mounting pins 42.

A kinematically coupled motion sequence of the crimping jaws 3 with the hollow shaft 8 is generated by way of the connecting elements 11, with the crimping jaws being arranged pivotably on the hollow shaft 8.

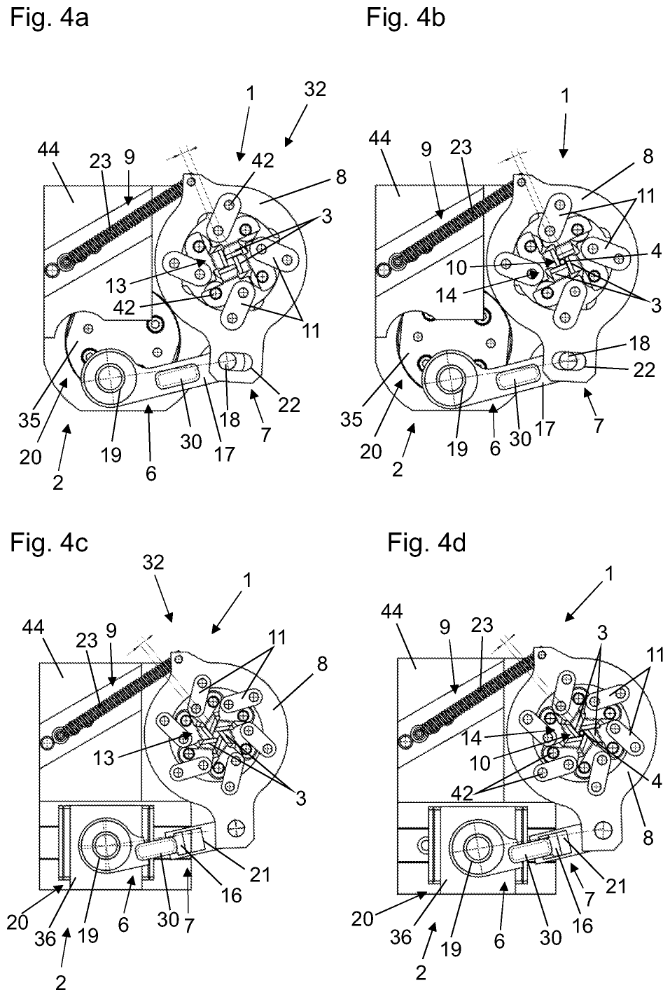

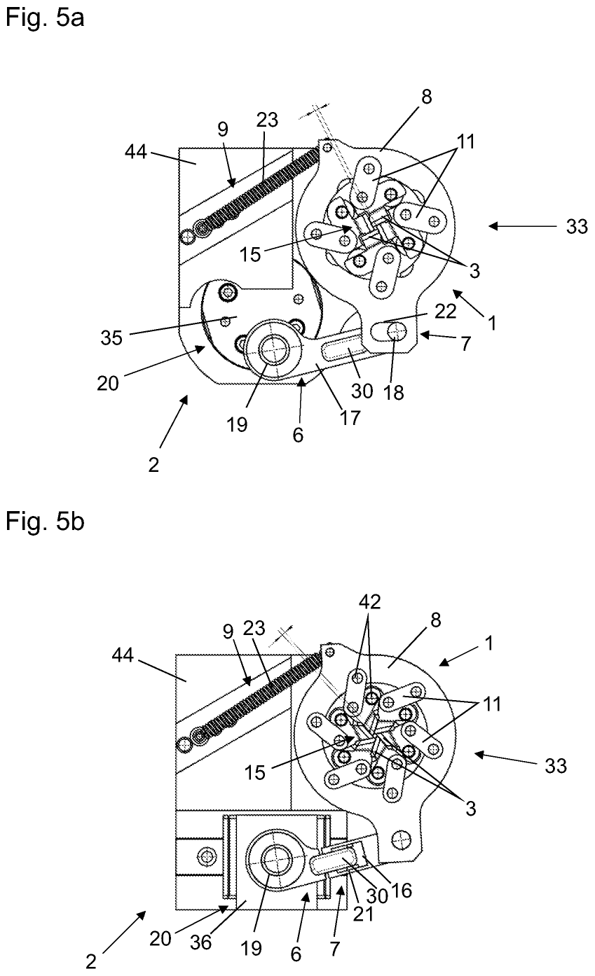

FIGS. 4a through 4d and FIGS. 5a and 5b show different positions of the crimping jaws 3 that correspond to the operating positions of the hollow shaft 8 and are defined by a relative position of the force-applying device 6 with respect to the compensating device 7.

FIG. 4a shows a crimping tool 1 having four crimping jaws 3 which are arranged by way of connecting means 11 and by way of mounting pins 42 on the hollow shaft 8 and a mounting ring 43, with the crimping jaws 3 being mounted moveably to the hollow shaft 8. The crimping jaws 3 are moveable by way of the hollow shaft 8 by being subjected to a force by the force storage means 9 or the force-applying device 6 into the processing position of an ejection position 12, an open position 13, a holding position 14 and a crimping position 15, FIG. 4a showing the open position 13 in which it is provided that the crimping connection 4 is fed to the crimping tool 1.

The pin 18 bears against a side surface of the slot 22 and by a pulling movement opens the crimping jaws 3 against an opposing pulling force produced by the force storage means 9.

A method of crimping a crimping connection 4 to a conductor 5 by a wire processing machine 2 will be described by way of example hereinafter, which can be supplemented by further method steps:
the crimping jaws 3 of the crimping tool 1 are moved by the force-applying device 6 by way of the hollow shaft 8 into the illustrated open position,
in a fitment position 32 a crimping connection 4 is fed to the crimping jaws 3,
the force-applying device 6 is moved relative to the compensating device 7, in which case the crimping jaws 3 transition into a holding position 14 in which the crimping connection 4 is arranged in force-locking relationship between the two crimping jaws 3,
the crimping tool 1 is pivoted by the movement device 31 from the fitment position 32 into a crimping position 33 about a horizontal axis 34, the force storage means 9 ensuring a force-locking connection 10 without crimping,
the conductor 5 is arranged region-wise within the crimping connection 4, and
the force-applying device 6 moves the crimping jaws 3 into a crimping position 15 by way of the hollow shaft 8.

FIG. 4b differs from FIG. 4a only in that the pin 18 does not generate a force transmission by way of a side surface of the slot 22, wherein the tension spring 32 brings the crimping jaws 3 together into the holding position 14 in order to secure the wire end ferrule 4 upon transport to a crimping position 33.

The crimping connection 4 is connected in force-locking relationship to the crimping jaws 3 in the holding position 14 of the crimping jaws 3 by the force storage means 9, wherein the hollow shaft 8 is rotated by way of the tensile force of the force storage means 9 from the open position 13 into the holding position 14 of the crimping jaws 3 and is held in the holding position 14.

The crimping connection 4 is held in the holding position 14 and during the pivotal movement out of the fitment position 32 into the crimping position 33 by the force storage means 9 in the form of the tension spring 23 by way of the force-locking connection 10 between the crimping connection 4 and the crimping jaws 3 in the crimping tool 1.

The force-applying device 6 is in an inactive relative position with respect to the compensating device 7, wherein exclusively the tensile force by the force storage means 9 acts on the crimping jaws 3 by way of the hollow shaft 8 to generate the holding position 14 as one of the four defined processing positions of the crimping jaws 3 and to hold same.

FIG. 4c differs from FIG. 4a in the number of crimping jaws 3 with six crimping jaws 3 and the drive unit 20 in the form of a linear drive 26. A hexagonal crimping profile is produced by way of the crimping jaws 6. In general for example a trapezoidal crimping profile can be produced after a crimp has been produced by way of a suitable number of crimping jaws 3.

The drive unit 20 in the form of an eccentric drive peripherally exerts a force on the hollow shaft 8 by rotation by way of the force-applying device 6 in the form of an eccentric lever, wherein a force acting on the hollow shaft 8 is only marginally increased or reduced by means of the tensile force.

FIG. 4d shows the wire processing machine 2 of FIG. 4c in the holding position 14, wherein the crimping tool 1 includes a force-applying device 6 which is acted upon with force by the drive unit 20 and the compensating device 7 is arranged at the force-applying device 6. The compensating device 7 is arranged on the hollow shaft 8 indirectly by way of a joint, wherein the four operating positions of the hollow shaft 8 are generated in dependence on a relative position of the force-applying device 6 relative to the compensating device 7 with an opening 21.

In the present operating position of the hollow shaft 8 the force storage means 9 produces a force-locking connection 10 between the crimping connection 4 and the six crimping jaws 3, wherein the force-locking connection 10 can be maintained during a pivotal movement by the at least one movement device 31 by way of the force storage means 9.

The crimping tool 1 has a force storage means 9 disposed at the main body 44, wherein a force-locking connection 10 is produced between the crimping connection 4 and the crimping jaws 3 by the force storage means 9 arranged peripherally at the hollow shaft 8 in a processing position of the crimping jaws 3, in which no force is transmitted to the crimping jaws by the force-applying device 6.

FIG. 5a shows the four crimping jaws 3 of the crimping tool 1 in the crimping position 15, wherein the force-applying device 6 bears against an opposite side surface of the slot 22 in comparison with FIG. 4a and transmits force in the same direction of rotation to the hollow shaft 8 as the tensile force of the tension spring 23.

In the crimping position 33 a connection of the crimping connection 4 to the conductor 5 with a quadrangular profile is produced.

FIG. 5b shows the crimping tool 1 with a linear motor 36 and six crimping jaws 3, wherein a sensor 30 with an included force measuring sensor and a travel measuring sensor for ascertaining crimping parameters is arranged at the force-applying device 6. In general a sensor 30 can also be arranged at or in the drive unit 20.

Actual values relating to crimping parameters like for example in relation to a position of the drive unit 20 and/or a traveled distance of the force-applying device 6 are ascertained by the sensor 30.

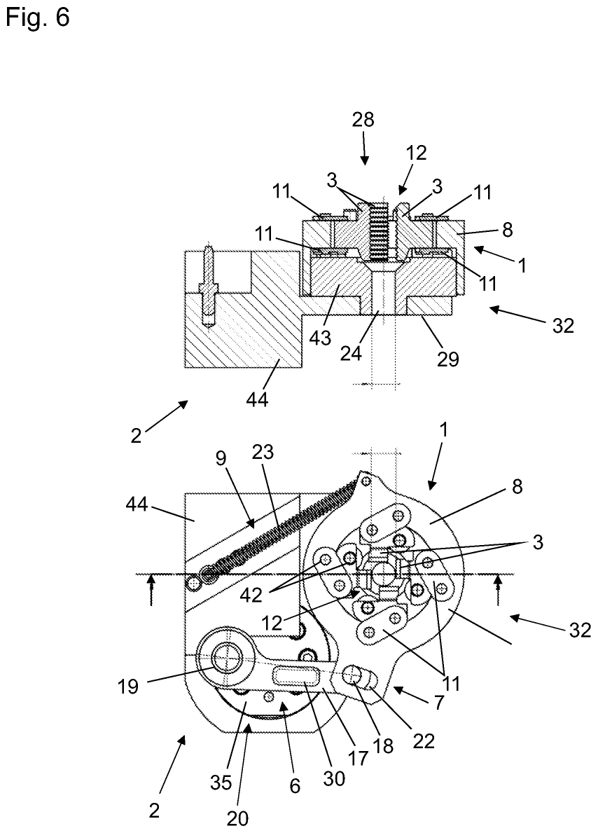

FIG. 6 shows the crimping tool 1 with four crimping jaws 3 in a view from the front side 28 and a sectional view arranged thereabove in the direction of the arrow. The crimping tool 1 has a through opening 24, through which the crimping connection 4 can be automatically loaded at both sides in that operating position of the hollow shaft 8, in which the crimping jaws 3 are disposed in the ejection position. Fitment under the effect of the force of gravity with crimping connections 4 and unloading of crimping connections 4 in the fitment position 32 has proven to be particularly desirable, in which case the crimping connection 4 in general in any position of the crimping tool 1 can be removed by an unloading device 25 and loaded by a loading device 26.

In the ejection position 12 the crimping jaws 3 are opened to such a width that the crimping connection 4 can drop out through the through opening 24 and/or can be fitted from the rear side 29 into the crimping tool 1.

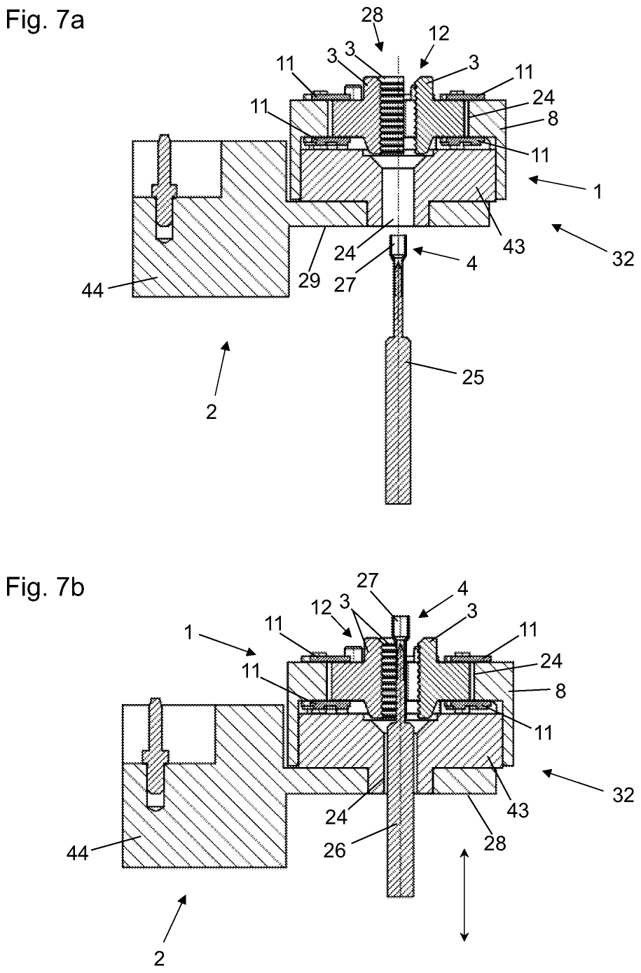

FIG. 7a shows the ejection position 12 of the crimping jaws 3, wherein the crimping connection 4 can be fed to and removed from the crimping jaws 3 from the front side 28 and the rear side 29 of the crimping tool 1 by way of the through opening 24. In a similar manner the conductor 5 (in the ejection position 12, the open position 13 and the holding position 14) can enter from the front side 28 and the rear side 29 between the crimping jaws 3.

Automatic unloading of the crimping connection 4 by an unloading device 25 in the form of an unloading mandrel is illustrated, wherein similarly the crimping connection 4 can be fed at both sides in an automated procedure by a loading device 26—for example in the form of a loading mandrel—.

FIG. 7b shows a loading device 26 in the form of a loading madrel during fitment of the crimping connection 4 in the form of a wire end ferrule 27. In the fitment position 32, the crimping position 33 and the position between the fitment position 32 and the crimping position 33 the crimping connection can be automatically removed from the crimping jaws 3 and/or fed to the crimping jaws 3. A similar consideration applies to the conductor 5 in relation to positioning in the crimping tool and in the crimping connection 4.

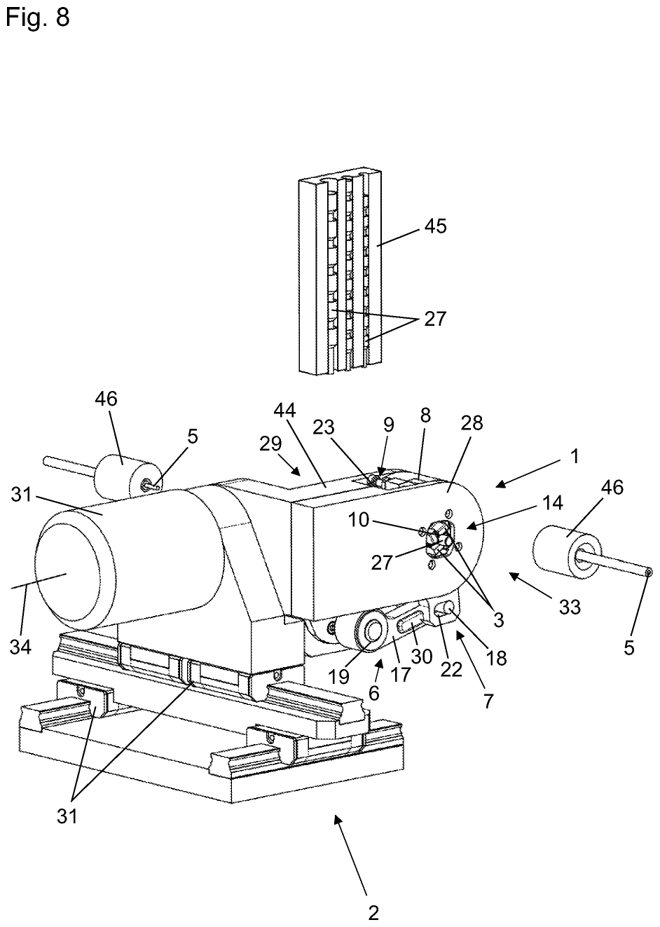

FIG. 8 shows a wire processing machine 2 with a crimping tool 1 including four crimping jaws 3 in a holding position 14, whereby the crimping connection 4 in the form of a wire end ferrule 27 is held in force-locking relationship in the crimping tool 1 by the force storage means 9. The crimping tool 1 is located in the crimping position 33, in which respect a crimping connection 4 has already been received from a crimping connection magazine 45 as a crimping connection feed arrangement.

A conductor 5 enclosed by a sheathing is fed to the crimping connection 4 by way of a wire feed device 46 from the front side 28 of the crimping tool 1. A conductor 5 can also be fed to the crimping jaws 3 by way of a further wire feed device 38 which can be identical to the wire feed device 36, from the rear side 29 and the crimping tool has a through opening 24 and in particular a hollow shaft 8 for loading and/or unloading at both sides. The conductor 5 can also be removed from the crimping connection 4 by means of the wire guide device. In general a loading device 26 and/or a unloading device 25 can be similarly provided for the crimping connection 4, but that is not absolutely necessary by virtue of the structural configuration of the crimping tool 1 and in particular by a movement device 31.

The wire processing machine 2 includes three movement devices 31, wherein two sliders moveable on rails ensure a linear movement of the crimping tool 1 in two Cartesian coordinates.

The third movement device 31 permits a pivotal movement of the crimping tool 1 about a horizontal axis 34 in order to pivot the crimping tool 1 between a vertical fitment position 32 to a horizontal crimping position 33, in which case no shuttle is needed for feeding the crimping connection 4 into the crimping tool 1. By way of example for that purpose a pivotal arm or a pivotal drive can be used. In general the crimping tool 1 can be moved in any angle and/or over any x-y distance, so that the crimping position 33 as well as the fitment position 32 can be arranged as desired in space and in particular in a particularly advantageous fashion different crimping connections 4 (for example of different crimping connection diameters) can be received from varying positions of the crimping connection magazine 45 by the crimping tool 1.

It is particularly advantageous on the wire processing machine 2 that it is now possible for the crimping tool 1 to be moveable in the direction of the conductor 5 and/or the crimping connection magazine 45, in which case the crimping connection magazine 45 and/or the conductor 5 can be positioned stationarily.

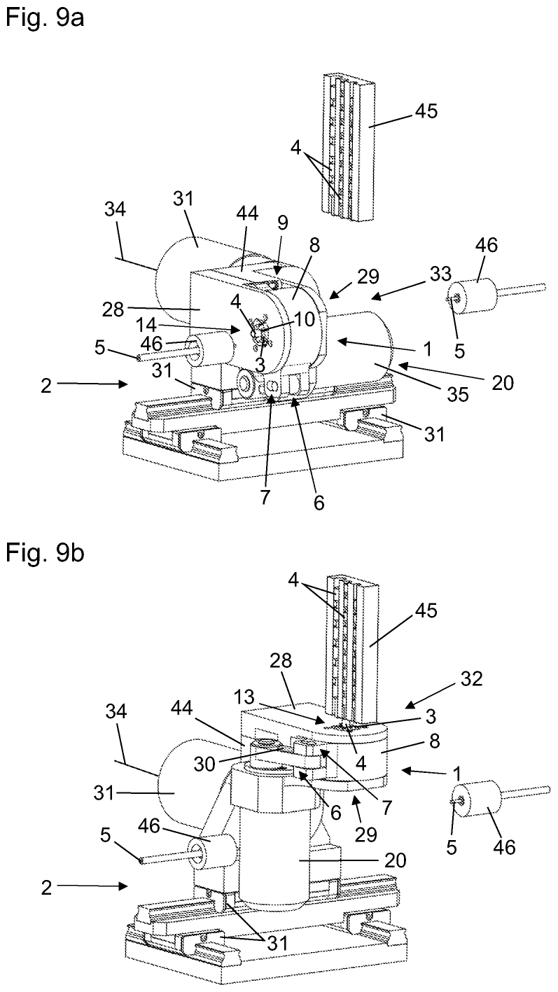

FIG. 9a differs from FIG. 8 solely by the direction of viewing the illustration. It is possible to see here the drive unit 20 which is in the form of a servo motor 35 as an eccentric drive for the force-applying device 6. The wire processing machine 2 however is not restricted to the specific drive unit 20, in which respect for example other kinds of drive can be provided for the relative movement of the force-applying device 6 with respect to the compensating device 7 in order to be able to adopt the different operating positions of the crimping jaws 3 by way of a movement of the hollow shaft 8. In addition to the open position 13 known from the state of the art and the crimping position 15 this arrangement provides a holding position 14 for force-locking connection 10—in particular for transport without premature crimping—as well as an ejection position 12 for loading and unloading at both sides.

FIG. 9b shows the crimping tool 1 in the fitment position 32 in a vertical orientation, wherein the crimping connection 4 drops under gravity out of the crimping connection magazine 45 between the crimping jaws 3 and is arranged in positively locking relationship by virtue of a collar in the crimping tool 1 in the open position 13.

Then initiated by the drive unit 20 the force-applying device 6 is moved relative to the compensating device 7 so that the force-applying device 6 does not exert any force on the crimping jaws 3 and the force storage means 9 rotates the hollow shaft 8 so that the crimping jaws 3 move into the holding position 14 for force-lockingly holding the crimping connection 4. Thereupon the movement device 31 can transfer the crimping tool 1 into the crimping position 32 without the crimping connection 4 being lost or without it being prematurely plastically deformed.

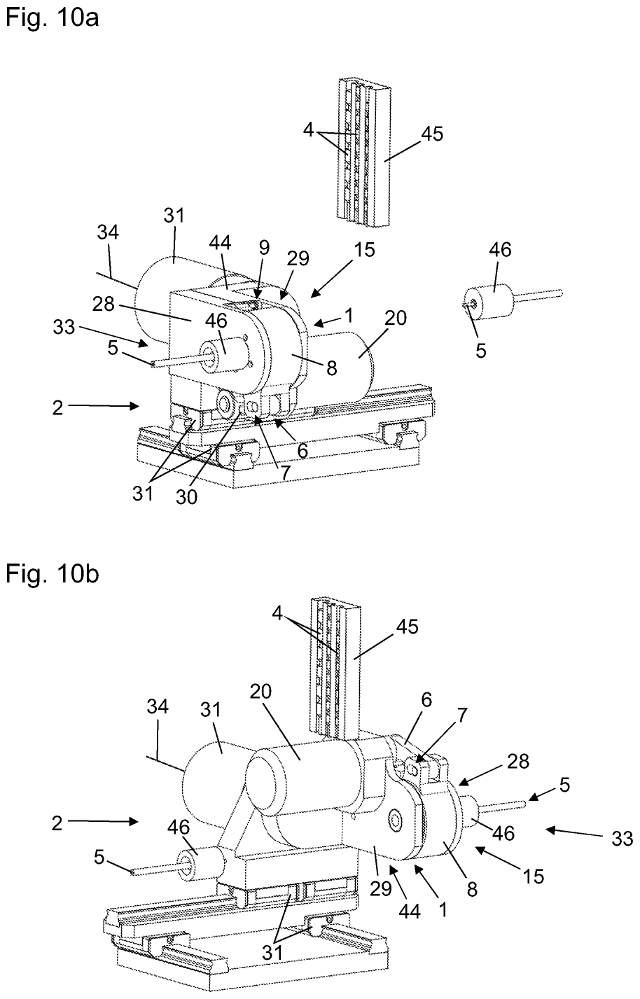

FIGS. 10a and 10b show the wire processing machine 2 in two different crimping positions 33, wherein the crimping tool 1 was pivoted about the horizontal axis 34 in different directions from a fitment position 32.

The front side 28 in the crimping positions 33 thereby faces in different directions whereby for example in dependence on the received crimping connection 3 and/or a diameter of the conductor 5, crimping can be effected particularly quickly as it is possible to prevent any time delay by virtue of conversion operations that may be required. The wire processing machine 2 can also be used in particularly flexible fashion.

In general it is also conceivable to feed the conductor 5 in the crimping position 33 shown in FIG. 10a and/or in the crimping position shown in FIG. 10b to the crimping tool 1 on both sides and/or to move the crimping tool 1 from the front side 28 and/or the rear side 29 in the direction of the conductor 5.

1-17. (canceled)

18. A wire processing machine, comprising:
at least one movement device;
at least one drive unit for producing force on the at least one movement device; and
a crimping tool, wherein the crimping tool is movable by the at least one movement device,
wherein the crimping tool comprises:
a main body;
at least one force-applying device, wherein force on the at least one force-applying device is applicable by the at least one drive unit;
at least two crimping jaws for crimping at least one crimping connection to at least one conductor;
at least one compensating device, wherein the at least one compensating device is at least one opening, by means of the at least one compensating device the at least one force-applying device is movable into a position in which substantially no force is transmittable to the at least two crimping jaws by virtue of the at least one force-applying device; and
at least one force storage means, the at least one force storage means acting in the position of the at least one force-applying device in which substantially no force is transmittable to the at least two crimping jaws by virtue of the at least one force-applying device,
wherein:
the at least two crimping jaws are movable relative to the main body by the at least one force-applying device;
the at least two crimping jaws are configured to adopt at least three processing positions by the at least one force-applying device, based on a relative position of the at least one force-applying device relative to the at least one compensating device; and
the at least one force storage means is configured to act on the at least two crimping jaws such that the at least one crimping connection is held by force-locking caused by the at least two crimping jaws during a movement of the crimping tool by virtue of the at least one movement device.

19. The wire processing machine as set forth in claim 18, wherein the crimping tool is configured to:
transport the at least one crimping connection from a fitment position to a crimping position; and
crimp the at least one crimping connection to the at least one conductor in the crimping position.

20. The wire processing machine as set forth in claim 18, wherein:
the crimping tool is pivotable by the at least one movement device into a fitment position for feeding the at least one crimping connection under force of gravity substantially vertically to the at least two crimping jaws or a crimping position spatially separate from the fitment position; and
the at least one crimping connection is removable from the at least two crimping jaws in the fitment position or the crimping position.

21. A wire processing machine, comprising:
at least one movement device;
at least one drive unit for producing force on the at least one movement device; and
a crimping tool, the crimping tool being movable by the at least one movement device,
wherein the crimping tool comprises:
a main body;
at least one force-applying device, wherein force on the at least one force-applying device is applicable by the at least one drive unit;
at least two crimping jaws for crimping at least one crimping connection to at least one conductor;
at least one compensating device; and
at least one force storage means, wherein the at least one force storage means is a tension spring;
wherein:
the at least two crimping jaws are movable relative to the main body by the at least one force-applying device;
the at least two crimping jaws are configured to adopt at least three processing positions by the at least one force-applying device, based on a relative position of the at least one force-applying device relative to the at least one compensating device; and
the at least one force storage means is configured to act on the at least two crimping jaws such that the at least one crimping connection is held by force-locking caused by the at least two crimping jaws during a movement of the crimping tool by virtue of the at least one movement device.

22. The wire processing machine as set forth in claim 21, wherein the crimping tool is configured to:
transport the at least one crimping connection from a fitment position to a crimping position; and
crimp the at least one crimping connection to the at least one conductor in the crimping position.

23. The wire processing machine as set forth in claim 21, wherein:
the crimping tool is pivotable by the at least one movement device into a fitment position for feeding the at least one crimping connection under force of gravity substantially vertically to the at least two crimping jaws or a crimping position spatially separate from the fitment position; and
the at least one crimping connection is removable from the at least two crimping jaws in the fitment position or the crimping position.

24. A wire processing machine comprising:
at least one movement device;
at least one drive unit for producing force on the at least one movement device; and
a crimping tool, the crimping tool being movable by the at least one movement device,
wherein the crimping tool comprises:
a main body;
at least one force-applying device, wherein force on the at least one force-applying device is applicable by the at least one drive unit;
at least two crimping jaws for crimping at least one crimping connection to at least one conductor;
at least one compensating device, wherein the at least one compensating device is at least one opening, by means of the at least one compensating device the at least one force-applying device is movable into a position in which substantially no force is transmittable to the at least two crimping jaws by virtue of the at least one force-applying device; and
at least one force storage means, wherein the at least one force storage means is a tension spring, the at least one force storage means acting in the position of the at least one force-applying device in which substantially no force is transmittable to the at least two crimping jaws by virtue of the at least one force-applying device,
wherein:
the at least two crimping jaws are movable relative to the main body by the at least one force-applying device;
the at least two crimping jaws are configured to adopt at least three processing positions by the at least one force-applying device, based on a relative position of the at least one force-applying device relative to the at least one compensating device; and
the at least one force storage means is configured to act on the at least two crimping jaws such that the at least one crimping connection is held by force-locking caused by the at least two crimping jaws during a movement of the crimping tool by virtue of the at least one movement device.

25. The wire processing machine as set forth in claim 24, wherein the crimping tool is configured to:
transport the at least one crimping connection from a fitment position to a crimping position; and
crimp the at least one crimping connection to the at least one conductor in the crimping position.

26. The wire processing machine as set forth in claim 24, wherein:
the crimping tool is pivotable by the at least one movement device into a fitment position for feeding the at least one crimping connection under force of gravity substantially vertically to the at least two crimping jaws or a crimping position spatially separate from the fitment position; and
the at least one crimping connection is removable from the at least two crimping jaws in the fitment position or the crimping position.
